(19) United States
(12) Patent Application Publication
(10) Pub. No.: US 2016/0210900 A1
(43) Pub. Date: Jul. 21, 2016

(54) DISPLAY APPARATUS AND DRIVING METHOD THEREOF

(71) Applicant: SAMSUNG DISPLAY CO., LTD., Yongin-si (KR)

(72) Inventor: Jongsoo KIM, Yongin-City (KR)

(21) Appl. No.: 14/832,241

(22) Filed: Aug. 21, 2015

(30) Foreign Application Priority Data
Jan. 20, 2015 (KR) 10-2015-0009340

(51) Int. Cl. G09G 3/32

(52) U.S. Cl. CPC G09G 3/3258; G09G 2330/021; G09G 2360/08; G09G 2320/043

(57) ABSTRACT

A display apparatus includes a pixel unit, a controller, and a scan driver. The pixel unit includes a plurality of pixels connected to a plurality of scan lines and a plurality of data lines. The controller determines a correlation between a current frame and a previous frame. The scan driver transmits scan signals to the scan lines. The scan signals have an increasing pulse width when the current frame and the previous frame have a predetermined degree of correlation.

### CROSS-REFERENCE TO RELATED APPLICATION

Korean Patent Application No. 10-2015-0009340, filed on Jan. 20, 2015, and entitled, “Display Apparatus and Driving Method Thereof,” is incorporated by reference herein in its entirety.

### BACKGROUND

1. Field

One or more embodiments described herein relate to a display apparatus and a method for driving a display apparatus.

2. Description of the Related Art

An organic light-emitting display forms images from light emitted by organic light-emitting diodes. The images are sequentially displayed at a frame frequency which satisfies one or more design requirements. Such a display has fast response speed and low power consumption compared with some other types of flat panel displays.

### SUMMARY

In accordance with one or more embodiments, a display apparatus includes a pixel unit including a plurality of pixels connected to a plurality of scan lines and a plurality of data lines; a controller to determine a correlation between a current frame and a previous frame; and a scan driver to transmit scan signals to the scan lines, the scan signals having an increasing pulse width when the current frame and the previous frame have a predetermined degree of correlation.

Each of the pixels may include a first transistor having a gate electrode connected to one of the plurality of scan lines and a first electrode connected to one of the plurality of data lines; a second transistor having a gate electrode connected to a second electrode of the first transistor, a first electrode connected to a power voltage line, and a second electrode connected to an emission device; and a third transistor having a gate electrode connected to the one of the scan lines connected to the gate electrode of the first transistor, a first electrode, and a second electrode, wherein the first and second electrodes are respectively connected to the second electrode and the gate electrode of the second transistor.

The controller may include a plurality of frame memories to store input image signals in a frame unit; and an image analyzer to compare image data of the current frame with image data of the previous frame. The controller may include a frame output to output one frame among a plurality of continuous frames when a number of the continuous frames in a reference frame time have the predetermined degree of correlation.

The scan driver may transmit, to the plurality of scan lines, the scan signals having the increasing pulse width during a first frame time, corresponding to a number of continuous frames having the predetermined degree of correlation within the reference frame time. A number of times that the scanning signals are transmitted to each pixel during the first frame time may be less than a number of continuous frames having the predetermined degree of correlation within the reference frame time.

The image analyzer may calculate one color ratio of the current frame and may determine whether the one color ratio has a value equal to or greater than a reference value. The controller may include a frame output to output the image data of the current frame which is different from the image data of the previous frame.

The pixel unit may be divided into a plurality of pixel areas, and the scan driver may transmit scan signals having an increasing pulse width during one frame time to scan lines of the pixel areas which correspond to areas where image data is changed in the current frame. The scan driver may transmit scan signals having an increasing pulse width during one frame time to rows of the pixel unit, which correspond to lines having changed image data in the current frame.

In accordance with one or more other embodiments, a method for driving a display apparatus includes determining correlation between a current frame and a previous frame; and transmitting scan signals having an increasing pulse width to a plurality of scan lines when the current frame and the previous frame have a predetermined degree of correlation.

Each of a plurality of pixels of the display device may include a first transistor having a gate electrode connected to one of the plurality of scan lines and a first electrode connected to one of the plurality of data lines; a second transistor having a gate electrode connected to a second electrode of the first transistor, a first electrode connected to a power voltage line, and a second electrode connected to an emission device; and a third transistor having a gate electrode connected to the one of the plurality of scan lines, to which the first electrode of the first transistor is connected, a first electrode, and a second electrode, wherein the first electrode and the second electrode are respectively connected to the gate electrode and the second electrode of the second transistor.

Transmitting the scan signals may include, when a number of continuous frames within a reference frame time have the predetermined degree of correlation, transmitting the scan signals having the increasing pulse width to the scan lines during a first frame time corresponding to the number of continuous frames having the predetermined degree of correlation. A number of times that scan signals are transmitted to each of the pixels during the first frame time may be less than the number of continuous frames having the predetermined degree of correlation during the reference frame time.

The method may include calculating one color ratio of the current frame, and determining whether the one color ratio has a value equal to or greater than a reference value. Transmitting the scan signals may include transmitting, during one frame time, scan signals having an increasing pulse width to a plurality of scan lines in pixel areas corresponding to areas of the current frame where image data is changed in the current frame. Transmitting the scan signals may include transmitting, during one frame time, scan signals having an increasing pulse width to rows of the pixel unit which correspond to lines in which image data is changed in the current frame.

In accordance with one or more embodiments, an apparatus includes an interface to receive image data of a current frame and image data of a previous frame; and a controller coupled to the interface to determine a correlation between the image data of the current and previous frames, the controller to generate at least one signal to increase a pulse width of one or more scan signals when the current frame and the previous frame are determined to have a predetermined degree of correlation. The predetermined degree of correlation may correspond to a predetermined ratio of same image data between the current and previous frames. The interface may be coupled to a first memory and a second memory, the first memory to provide the image data of the current frame and the second memory to provide the image data of the previous frame.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display apparatus;

FIG. 2 illustrates an embodiment of a pixel;

FIG. 3 illustrates another embodiment of a pixel;

FIG. 4 illustrates an embodiment of a controller;

FIG. 5 illustrates an example of control signals for the display apparatus;

FIG. 6 illustrates another example of control signals for the display apparatus;

FIG. 7 illustrates another embodiment of a display apparatus;

FIG. 8 illustrates another embodiment of a controller;

FIG. 9 illustrates an example of control signals for a display apparatus;

FIG. 10 illustrates another embodiment of a display apparatus;

FIG. 11 illustrates another embodiment of a controller; and

FIG. 12 illustrates another embodiment of a display apparatus.

### DETAILED DESCRIPTION

Example embodiments are described with reference to the drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments. Like reference numerals refer to like elements throughout.

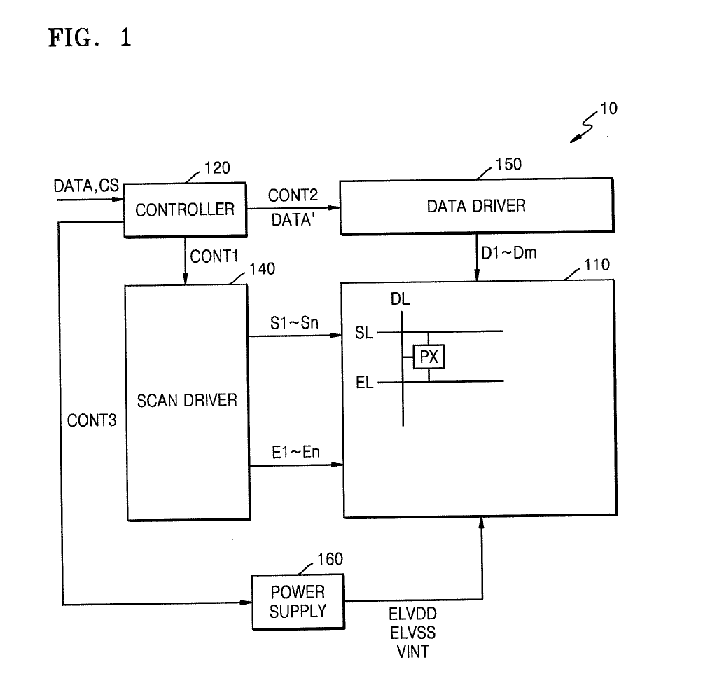

FIG. 1 illustrates an embodiment of a display apparatus 10 which includes a pixel unit 110, a controller 120, a scan driver 140, a data driver 150, and a power supply 160. The display apparatus 10 may be, for example, an organic light-emitting display apparatus.

The pixel unit 110 includes a plurality of scan lines SLs, a plurality of data lines DLs, a plurality of emission control lines ELs, a first power voltage line, and a plurality of pixels PXs. The scan lines SLs are separated from each other at regular intervals, are arranged in a row direction, and respectively transmit scanning signals S1 to Sn. The data lines DLs are separated from each other at regular intervals, are arranged in a column direction, and respectively transmit data signals D1 to Dm. The scan lines SLs and the data lines DLs are arranged in a matrix form. The pixels PXs are arranged at areas where the scan lines SLs and the data lines DLs cross each other. The emission control lines ELs respectively transmit emission control signals E1 to En. The first power voltage line transmits a first power voltage ELVDD and may be implemented in a grid or mesh form.

The controller 120 receives input image signals DATA and input control signals CSs from a source, e.g., an external system. The controller 120 may be implemented to have or be coupled to a plurality of frame memories and performs a function for controlling the frame memories. For example, the controller 120 may be implemented as a central processing unit (CPU) or a microprocessor unit (MPU) in a mobile terminal having the display apparatus 10.

Input control signals CSs may include main clock signals and timing signals. The controller 120 generates control signals that control driving timings of the scan driver 140 and the data driver 150.

The controller 120 generates first to third control signals CONT1 to CONT3 based on the input control signals CSs and outputs the generated first to third control signals CONT1 to CONT3 to the scan driver 140, the data driver 150, and the power supply 160. Each of the first to third control signals CONT1 to CONT3 may include one or more control signals. For example, the first control signals CONT1 may include a vertical synchronization signal Vsync, a horizontal synchronization signal Hsync, a scan start signal SSP that indicates a scan start, a shift clock signal SSC that designates a scan pulse width, etc. The second control signals CONT2 may include a vertical synchronization signal Vsync, a horizontal synchronization signal Hsync, a data start signal DSP that indicates a start of data, an output enable signal DE that controls data signals to be output to the data lines DLs, a sampling clock signal DSC, etc.

The controller 120 stores the input image signals DATA in a frame unit and transmits the stored image signals DATA′ to the data driver 150. The image signals DATA′ transmitted by the controller 120 may be image signals that are the same as the input image signals DATA or that are corrected or converted. The controller 120 determines uniformity of frames by comparing image data of at least two adjacent frames and adjusts timings of a high level and a low level of the first control signals CONT1 and the second control signals CONT2 output to the scan driver 140 and the data driver 150 in accordance with the uniformity of the frames. The controller 120 selectively outputs the frames to the data driver 150.

The scan driver 140 is connected to the scan lines SLs in the pixel unit 110, generates scan signals S1 to Sn having a gate-on voltage according to the first control signals CONT1, and sequentially transmits the generated scan signals S1 to Sn to the scan lines SLs. The scan driver 140 may include a shift register. The gate-on voltage may be a high-level or low-level voltage. When the scan signals S1 to Sn have a gate-on voltage, a switching transistor or compensation transistor of pixels PXs connected to the scan lines SLs are turned on. The scan driver 140 varies a pulse width of scan signals S1 to Sn according to the first control signals CONT1. The pulse width indicates a period of the gate-on voltage.

Also, the scan driver 140 generates emission control signals E1 to En having a gate-on voltage according to the first control signals CONT1 and sequentially transmits the generated emission control signals E1 to En to the emission control lines ELs. The scan driver 140 varies a pulse width of the emission control signals E1 to En according to the first control signals CONT1.

The data driver 150 is connected to the data lines DLs in the pixel unit 110 and transmits data signals D1 to Dm according to the second control signals CONT2. The data driver 150 converts the image signals DATA′ input by the controller 120 to data signals in a voltage or current form. The data driver 150 controls an output of the data signals D1 to Dm according to the second control signals CONT2.

The power supply 160 generates a first power voltage ELVDD and a second power voltage ELVSS. The power supply 160 applies a first power voltage ELVDD and a second power voltage ELVSS, which are generated according to the third control signals CONT3, to the pixel unit 110. The level of the first power voltage ELVDD is greater than that of the second power voltage ELVSS. The power supply 160 generates an initialization voltage VINT according to the third control signals CONT3 and applies the generated initialization voltage VINT to the pixel unit 110.

The controller 120, the scan driver 140, the data driver 150, and the power supply 160 are formed as separate integrated circuit chips or as a single integrated circuit chip, and may be directly mounted on a substrate on which the pixel unit 110 is formed, mounted on a flexible printed circuit film, attached to a substrate in a tape carrier package (TCP) form, or directly formed on a substrate.

According to one exemplary embodiment, the scan driver 140 generates the emission control signals E1 to En and transmits the generated emission control signals E1 to En to the pixel unit 110. In another embodiment, the emission control signals E1 to En may be generated by a separate emission control driver and transmitted to the pixel unit 110. The power supply 160 generates the initialization voltage VINT and applies the generated initialization voltage VINT to the pixel unit 110. In another embodiment, the initialization voltage VINT may be generated by a separate initialization voltage supplier and applied to the pixel unit 110.

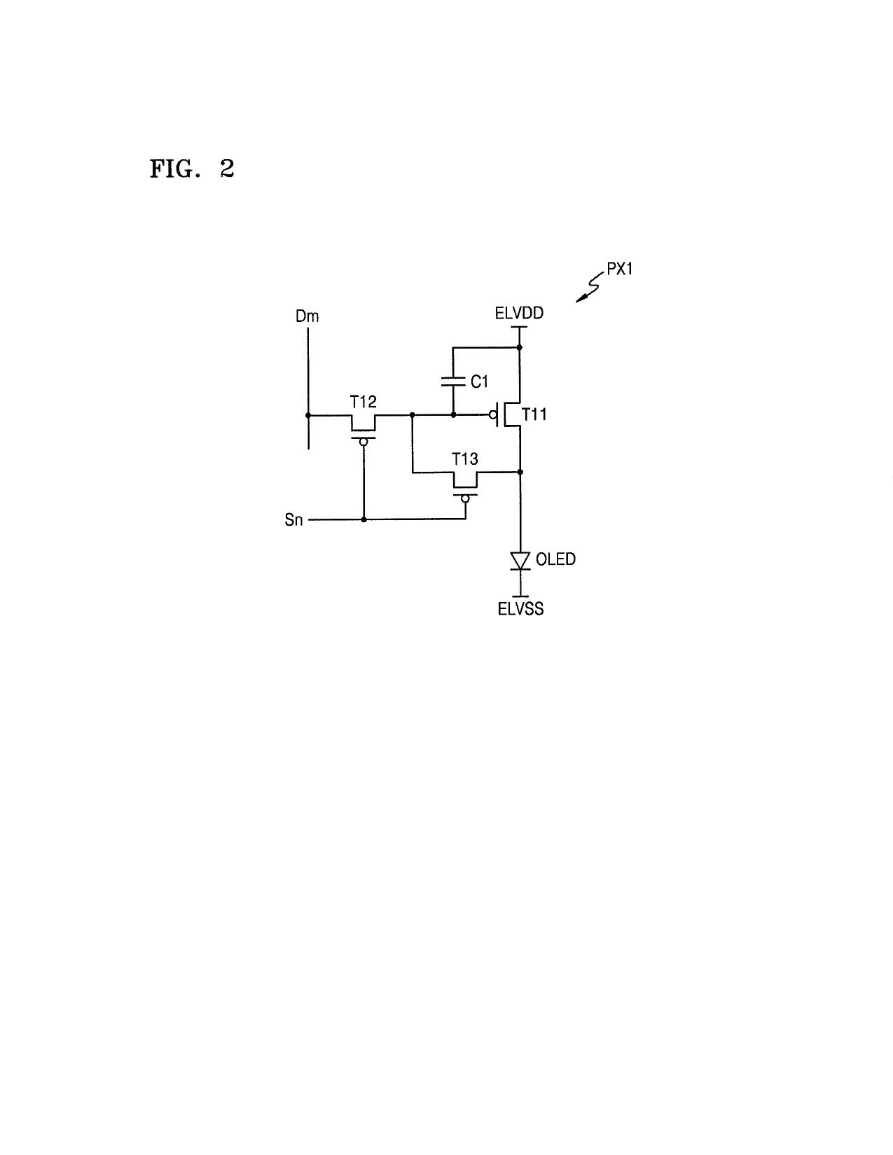

FIG. 2 illustrates an embodiment of a pixel PX1, which, for example, may be representative of the pixels in the display apparatus 10. Referring to FIG. 2, the pixel PX1 includes first to third transistors T11 to T13, a capacitor C1, and an emission device. The emission device may be an organic light-emitting diode (OLED).

For convenience of explanation, the pixel PX1 will be described as one at an m^{th} column and n^{th} row, e.g., the pixel PX1 is disposed on the n^{th} row and connected to a scan line corresponding to the n^{th} row and a data line corresponding to the m^{th} column. The pixel PX1 is connected to a scan line transmitting a scan signal Sn to the second transistor T12 and the third transistor T13, a data line crossing the scan line and transmitting a data signal Dm, and a power voltage line applying the first power voltage ELVDD.

The first transistor T11 includes a gate electrode connected to a first electrode of the capacitor C1, a first electrode connected to the power voltage line, and a second electrode connected to an anode of the OLED. The first transistor T11 functions as a driving transistor and applies a current to the OLED by receiving the data signal Dm according to a switching operation of the second transistor T12.

The second transistor T12 includes a gate electrode connected to the scan line, a first electrode connected to the data line, and a second electrode connected to the gate electrode of the first transistor T11. The second transistor T12 is turned on by the scan signal Sn transmitted from the scan line and functions as a switching transistor that transmits the data signal Dm, which is transmitted from the data line, to the first electrode of the first transistor T11.

The third transistor T13 includes a gate electrode connected to the scan line, a first electrode connected to the second electrode of the first transistor T11, and a second electrode connected to the first electrode of the first transistor T11. The third transistor T13 is turned on by the scan signal Sn transmitted from the scan line and diode-connects the first transistor T11. A threshold voltage of the first transistor T11 diode-connected by the third transistor T13 is compensated for at an initial stage of a data write, and the third transistor T13 functions as a compensation transistor.

The capacitor C1 includes the first electrode connected to the gate electrode of the first transistor T11, the second electrode of the third transistor T13, and the second electrode of the second transistor T12, and a second electrode connected to the first power voltage line.

A cathode of the OLED is connected to a second power source supplying the second power voltage ELVSS. The OLED emits light by receiving a current from the first transistor T11 and displays an image.

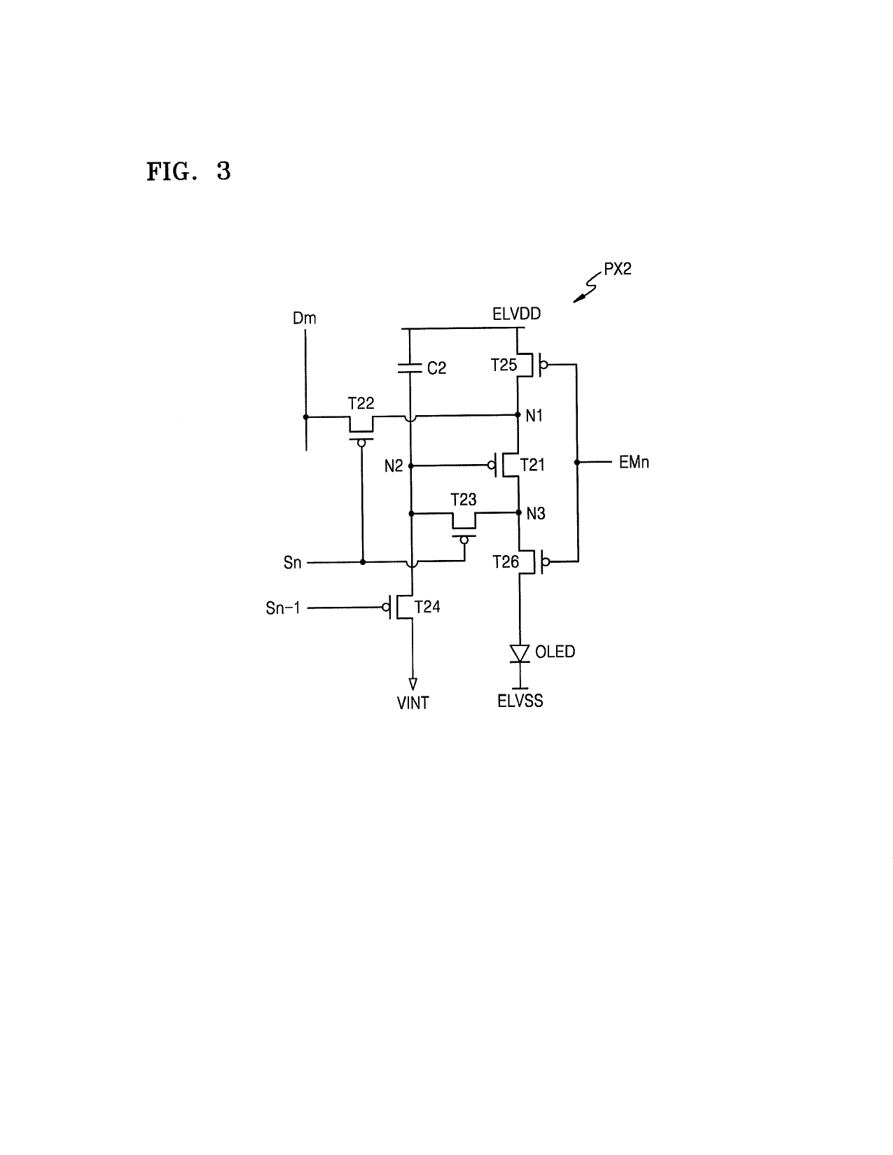

FIG. 3 illustrates another embodiment of a pixel PX2, which, for example, may be representative of the pixels in the display apparatus 10. Referring to FIG. 3, the pixel PX2 includes first to sixth transistors T21 to T26, a capacitor C2, and an emission device. The emission device may be an OLED.

For convenience of explanation, the pixel PX2 is located at an m^{th} column and n^{th} row, e.g., the pixel PX2 is disposed on the n^{th} row and is connected to a scan line corresponding to the n^{th} row and a scan line corresponding to an (n−1)^{th} row prior to the n^{th} row. In one embodiment, the PX2 is connected to a scan line corresponding to a particular row and a scan line corresponding to a previous row, e.g., may be connected to two scan lines among the plurality of scan lines.

The pixel PX2 is connected to a first scan line transmitting a current scan signal Sn to the second transistor T22 and the third transistor T23, a second scan line transmitting a previous scan signal Sn−1 to the fourth transistor T24, an emission control line transmitting an emission control signal EMn to the fifth transistor T25 and the sixth transistor T26, a data line crossing the first scan line and transmitting the data signal Dm, a first power voltage line transmitting a first power voltage ELVDD, and an initialization voltage line transmitting an initialization voltage VINT to initialize first transistor T21.

The first transistor T21 includes a gate electrode connected to a first electrode of the capacitor C2, a first electrode connected to a first node N1, and a second electrode connected to a third node N3. The first transistor T21 functions as a driving transistor and applies a current to the OLED by receiving the data signal Dm according to a switching operation of the second transistor T22.

The second transistor T22 includes a gate electrode connected to the first scan line, a first electrode connected to the data line, and a second electrode connected to the first electrode of the first transistor T11 at the first node N1. The second transistor T22 is turned on by the current scan signal Sn transmitted from the first scan line and functions as a switching transistor that transmits the data signal Dm, which is transmitted from the data line, to the first electrode of the first transistor T21.

The third transistor T23 includes a gate electrode connected to the first scan line, a first electrode connected to the second electrode of the first transistor T21 at the third node N3, and a second electrode connected to the first electrode of the capacitor C2, a second electrode of the fourth transistor T24, and the gate electrode of the first transistor T21 at a second node N2. The third transistor T23 is turned on by the current scan signal Sn transmitted from the first scan line and diode-connects the first transistor T11. A threshold voltage of the first transistor T21 diode-connected by the third transistor T23 is compensated for at an initial stage of a data write, and the third transistor T23 functions as a compensation transistor.

The fourth transistor T24 includes a gate electrode connected to the second scan line, a first electrode connected to the initialization voltage line, and the second electrode connected to the first electrode of the capacitor C2, the second electrode of the third transistor T23, and the gate electrode of the first transistor T21 at the second node N2. The first electrode and the second electrode of the fourth transistor T24 become a source electrode and a drain electrode in accordance with a direction of a current. The fourth transistor T24 is turned on by the previous scan signal Sn−1 transmitted from the second scan line and performs an initialization operation of initializing a voltage of the gate electrode of the first transistor 121 by transmitting the initialization voltage VINT to the gate electrode of the first transistor T21.

The fifth transistor 125 includes a gate electrode connected to the emission control line, a first electrode connected to the first power voltage line, and a second electrode connected to the first electrode of the first transistor T21, and the second electrode of the second transistor 122 at the first node N1.

The sixth transistor T26 includes a gate electrode connected to the emission control line, a first electrode connected to the second electrode of the first transistor T21 and the first electrode of the third transistor T23 at the third node N3, and a second electrode connected to the anode of the OLED. The fifth transistor T25 and the sixth transistor T26 are simultaneously turned on by the emission control signal EMn transmitted from the emission control line. Then, the first power voltage ELVDD is applied to the OLED to allow current to flow in the OLED.

The capacitor C2 includes the first electrode connected to the gate electrode of the first transistor T21, the second electrode of the third transistor T23, and the second electrode of the fourth transistor T24 at the second node N2, and a second electrode connected to the first power voltage line.

A cathode of the OLED is connected to a second power source supplying the second power voltage ELVSS. The OLED emits light by receiving current from the first transistor T21 to display an image.

During an initialization time, the pixel PX2 receives the previous scan signal Sn−1 having a gate-on voltage at a low level from the second scan line. Then, the fourth transistor T24 is turned on based on the previous scan signal Sn−1. The initialization voltage VINT is applied to the gate electrode of the first transistor T21 via the fourth transistor T24, and the gate electrode of the first transistor T21 is initialized.

Then, during a data write time, the pixel PX2 receives the current scan signal Sn having a gate-on voltage from the first scan line. Then, the second transistor T22 and the third transistor T23 are turned on based on the current scan signal Sn. The data signal Dm transmitted from the data line via the second transistor T22 is transmitted to the first node N1. The first transistor T21 is diode-connected by the third transistor T23 that is turned on and biased in a forward direction, and a compensation voltage DATA+Vth (Vth has a negative (−) value), which is decreased by a threshold voltage Vth of the first transistor T21, is applied to the gate electrode of the first transistor T21. The first power voltage ELVDD and the compensation voltage DATA+Vth are applied to both terminals of the capacitor C2, and electric charges corresponding to a voltage difference between the terminals of the capacitor C2 are stored in the capacitor C2.

During an emission time, the pixel PX2 receives the emission control signal EMn having a gate-on voltage from the emission control line. Then, the fifth transistor T25 and the sixth transistor T26 are turned on based on the emission control signal EMn. Accordingly, a current corresponding to a voltage difference between the voltage of the gate electrode of the first transistor T21 and the first power voltage ELVDD is generated, and the generated current is applied to the OLED via the sixth transistor T26.

The pixels PX1 and PX2 of FIGS. 2 and 3 compensate for the threshold voltages of the first transistors T11 and T21 due to the third transistors T13 and T23 at the initial stage of the data write. The higher the resolution of the display apparatus, the shorter the line time required to operate one row. Therefore, the time required to compensate for the threshold voltage of the driving transistor decreases, and the quality of the resulting image may be degraded due to the generation of Mura in the image.

In accordance with one or more embodiments, a determination is made as to whether the image data of each frame has uniformity. When the current frame and the previous frame have uniformity, the pulse width of the scan signals increases and the output timing of the data signals is adjusted. The pulse width may be increased in increments, where each increment is determined by taking into account a sufficient amount of time required to compensate for the threshold voltage of the driving transistor. As the pulse width of the scan signals increases, the data write time of the pixel PX21 or PX2 may increase. Thus, the time required to compensate the threshold voltage of the driving transistor may be sufficiently secured.

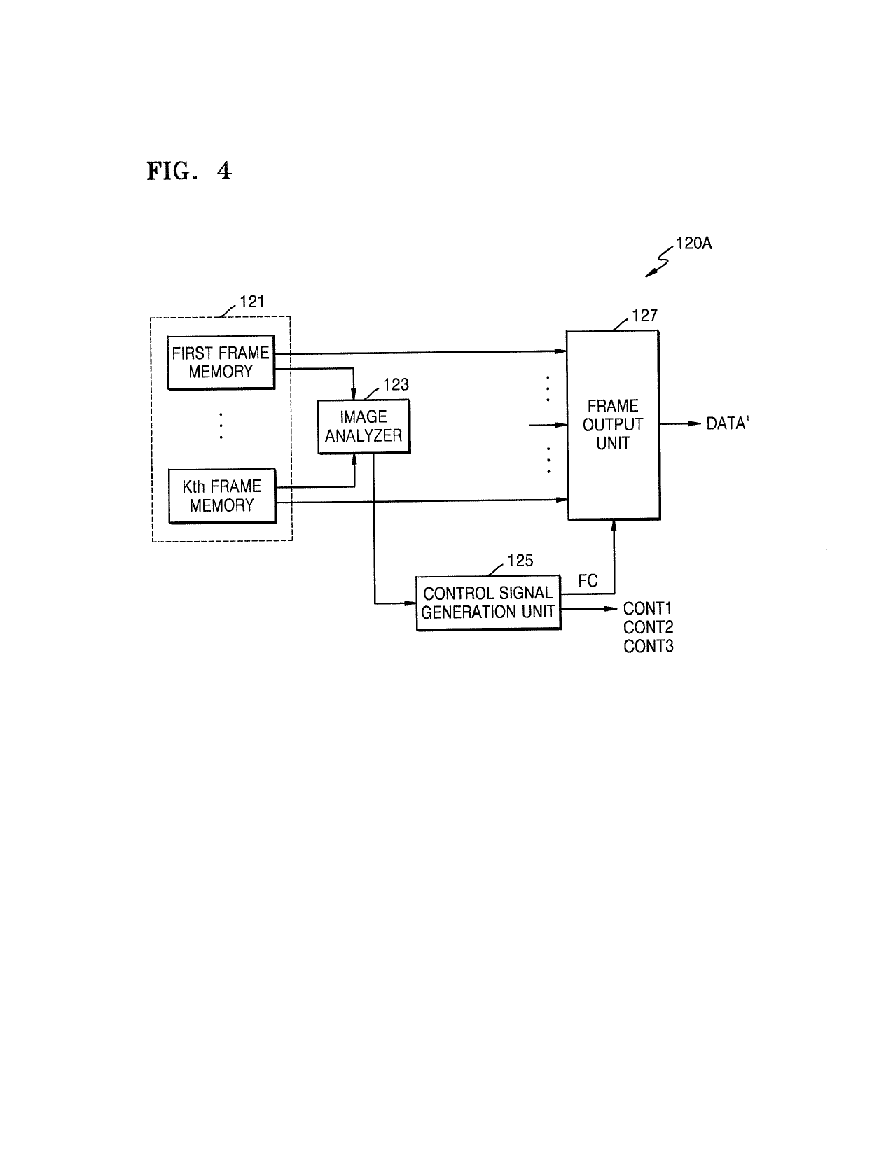

FIG. 4 illustrates an embodiment of a controller 120A which includes a frame input unit 121, an image analyzer 123, a control signal generation unit 125, and a frame output unit 127. The frame input unit 121 may include first to K^{th} frame memories. A frame memory may be implemented, for example, as random access memory (RAM) configured to store image data corresponding to one frame. The frame input unit 121 may be in the controller 120A or separate from and coupled to the controller 120A.

The number of frame memories may be the same as or one greater than the number of frames within the reference frame time. For example, when the reference frame time is equal to two frame times, the number of frame memories may be two or three. When there are two frame memories, each frame memory may include a buffer. The frame input unit 121 may store frames in frame memories such that the frames to be input and output to the frame memories may be stored and output without data loss.

The image analyzer 123 compares image data of a first frame with image data of a second frame and determines a correlation between the first and second frames. The first frame may be a current frame and a second frame may be a previous frame. The previous frame may be a frame right before or at least one frame before the current frame. The image analyzer 123 compares the image data of the current frame with the image data of the previous frame and determines uniformity (correlation) between the current frame and the previous frame. The image analyzer 123 may compare corresponding image data of the current frame and the previous frame in pixel unit or block unit. In accordance with one embodiment, the image data of the current and previous frames may be considered to have uniformity (correlation) when the image data of the previous and current frames are the same or a predetermined ratio of items of image data are the same. In another embodiment, uniformity of the image data of the current and previous frames may be determined by a different method, e.g., differential values, absolute values of differential values, sizes of motion vectors.

The image analyzer 123 determines the uniformity of frames that are continuously input in a time unit (hereinafter, referred to as a ‘reference frame time’) during which a reference number of frames are input. The reference frame time may have at least two frame times. A counter may be included to count the number of frames. The counter may be reset when the number of frames is equal to the reference number.

The control signal generation unit 125 generates the first to third control signals CONT1 to CONT3 and outputs the generated first to third control signals CONT1 to CONT3 to the scan driver 140, the data driver 150, and the power supply 160. When there are two or more frames that have uniformity (e.g., a predetermined degree or range of correlation) and are continuous within the reference frame time, the first control signals CONT1 and the second control signals CONT2 output by the control signal generation unit 125 vary. For example, the control signal generation unit 125 may vary the first control signals CONT1 and the second control signals CONT2 to decrease the frame frequency. It may be understood that frames having uniform image data may be displayed as still images on a screen. When the frame frequency decreases, reproduction of a moving image may be cut. On the contrary, even when the frame frequency decreases, the definition of a still image may still not be affected.

In addition, the image analyzer 123 may calculate one color ratio of the current frame and determines whether the one color ratio of the current frame is equal to or higher than a reference ratio. When the current frame and the previous frame have uniformity and the one color ratio is equal to or higher than a reference ratio, the first control signals CONT1 and the second control signals CONT2 output by the control signal generation unit 125 may vary to decrease the frame frequency. In the case of a monochrome image. Mura is clearly observed. Thus, the frame frequency may not be changed if a still image has a low one color ratio.

When the frame frequency decreases, the first control signals CONT1 and the second control signals CONT2 output by the control signal generation unit 125 vary to adjust an output timing of a scan signal, a pulse width of a scan signal, and/or an output timing of a data signal. When the frame frequency decreases, the scan driver 140 increases the pulse width of the scan signal in comparison with a case where the scan driver 140 operates by an original frame frequency, in accordance with the first control signals CONT1, and the scan signal having the increasing pulse width is output to the pixel unit 110. The data driver 150 increases a time required to output a data signal in accordance with the second control signals CONT2. Due to the increase of the pulse width of the scan signal, a data write time of the pixels PXs and a time required to compensate for the threshold voltage of the driving transistor increase. Accordingly, the occurrence of Mura in an image may decrease.

The control signal generation unit 125 generates a frame control signal FC and outputs the generated frame control signal FC to the frame output unit 127.

The frame output unit 127 receives the frame control signal FC from the control signal generation unit 125, selects the image data stored in at least one of the first to K^{th} frame memories, and outputs the selected image data to the data driver 150. The frame output unit 127 selects only one of the frames that are continuous and have uniformity within the reference frame time in accordance with the frame control signal FC. The selected frame is output to the data driver 150, but the remaining frames are not output to the data driver 150. The frame output unit 127 delays a predetermined frame time in accordance with the number of frame memories and the length of the reference frame time and outputs frames.

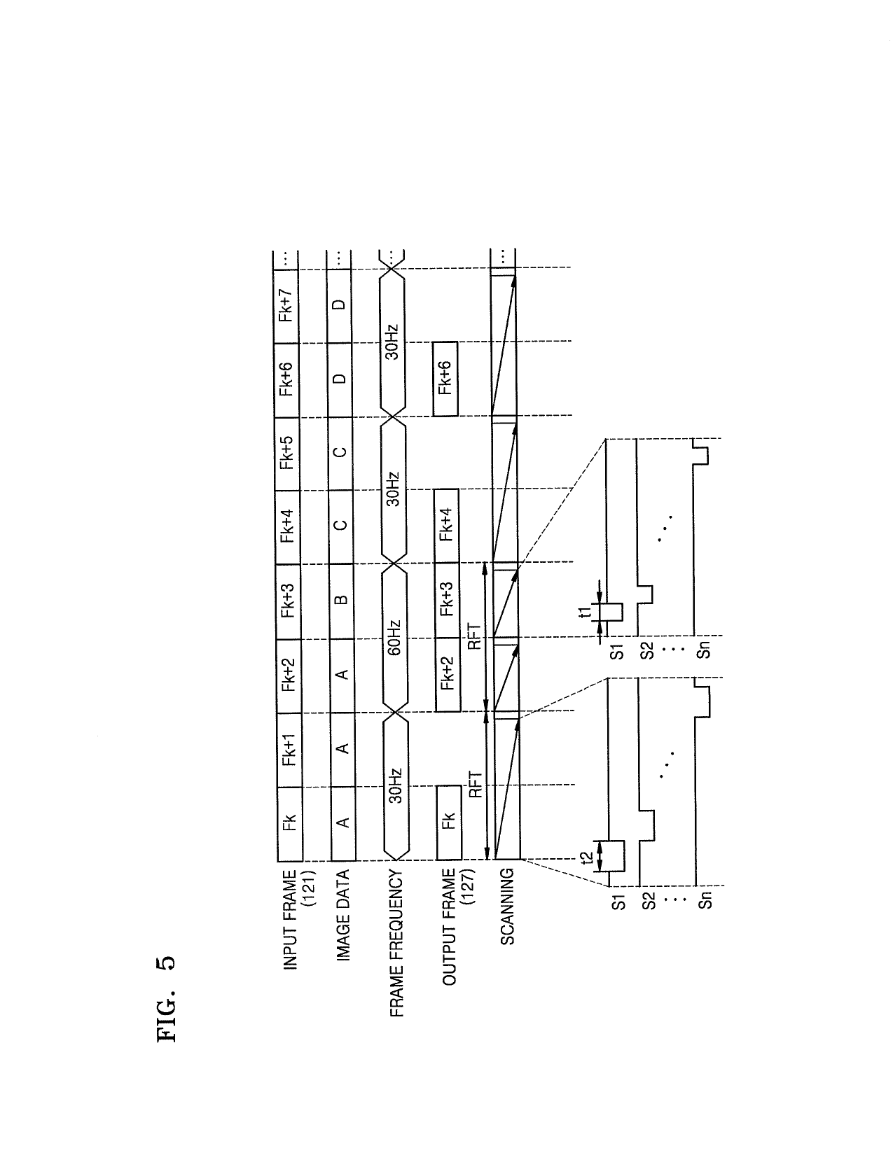

FIG. 5 illustrates an example of control signals for the display apparatus 10. In the present exemplary embodiment, the original frame frequency is equal to 60 Hz, the frame input unit 121 has three frame memories, and a reference frame time RFT has two frame times. In other embodiments, the original frame frequency, the number of frame memories in the frame input unit 121, and/or the reference frame time RFT may be different.

Referring to FIG. 5, image signals (Fk, Fk+1, . . . , Fk+7, . . . ) are sequentially input and stored in the frame input unit 121 in a frame unit. The frame input unit 121 stores the input image signals to empty frame memories.

The image analyzer 123 compares image data of the current frame with image data of the previous frame (e.g., Fk/Fk+1, Fk+1/Fk+2, Fk+2/Fk+3, Fk+3/Fk+4, . . . ) and determines whether the current frame and the previous frame have uniformity. The image analyzer 123 determines the uniformity of frames input during the reference frame time RFT. For example, the image analyzer 123 determines the uniformity of frames, for example, first and second frames (Fk/Fk+1), third and fourth frames (Fk+2/Fk+3), fifth and sixth frames (Fk+4/Fk+5), seventh and eighth frames (Fk+6/Fk+7), or the like, which are input during two frame times.

The control signal generation unit 125 determines a frame frequency, in accordance with a determination result regarding the uniformity of frames, in a reference frame time RFT unit. When it is determined that the first and second frames (Fk/Fk+1) have uniformity, the control signal generation unit 125 changes the frame frequency of the first and second frames (Fk/Fk+1) to another value (e.g., 30 Hz) and generates control signals in response thereto. When it is determined that the third and fourth frames (Fk+2/Fk+3) are different from each other, the control signal generation unit 125 maintains the frame frequency of the third and fourth frames (Fk+2/Fk+3) at 60 Hz. The control signal generation unit 125 changes frame frequencies of the fifth and sixth frames (Fk+4/Fk+5) and seventh and eighth frames (Fk+6/Fk+7) to the other value (e.g., 30 Hz) and generates control signals in response thereto.

The frame output unit 127 outputs frames after two frame time delays. The frame output unit 127 selects and outputs each one of the first and second frames (Fk/Fk+1), the fifth and sixth frames (Fk+4/Fk+5), and the seventh and eighth frames (Fk+6/Fk+7), that is, the first, fifth, and seventh frames (Fk, Fk+4, and Fk+6). The frame output unit 127 selects and outputs different frames, that is, the third and fourth frames (Fk+2/Fk+3), in the reference frame time RFT unit.

For example, the first frame (Fk) and the second frame (Fk+1) are input to the frame input unit 121 and the image analyzer 123 determines the uniformity thereof. In this case, the second frame (Fk+1) having uniformity with the first frame (Fk) may be erased from a frame memory. When the first frame (Fk) and the second frame (Fk+1) have uniformity, the control signal generation unit 125 changes the frame frequency thereof to 30 Hz. While the third frame (Fk+2) and the fourth frame (Fk+3) are being sequentially input to the frame input unit 121, the frame output unit 127 outputs the first frame (Fk) to the data driver 150.

Similarly, the image analyzer 123 determines the uniformity of the third frame (Fk+2) and the fourth frame (Fk+3). The control signal generation unit 125 changes the frame frequency of the first frame (Fk) and the second frame (Fk+1) to 60 Hz because the first frame (Fk) and the second frame (Fk+1) do not have uniformity. While the fifth frame (Fk+4) and the sixth frame (Fk+5) are being sequentially input to the frame input unit 121, the frame output unit 127 sequentially outputs the frame (Fk+2) and the fourth frame (Fk+3) to the data driver 150.

The scan driver 140 outputs, to the pixel unit 110, scan signals having a second pulse width t2 during two frame times, in accordance with the first control signals CONT1 corresponding to the frame frequency of 30 Hz. The data driver 150 outputs, to the pixel unit 110, image data of frames, which is input by the frame output unit 127, in synchronization with the scan signals, according to the second control signals CONT2 corresponding to the frame frequency of 30 Hz.

When the frame frequency of 30 Hz is used, scanning is performed once in each row during two frame times. In this case, the scan signal having the second pulse width t2 is transmitted to the pixels PXs. The second pulse width t2 is greater than a first pulse width t1 when the frame frequency of 60 Hz is used. Accordingly, as the data write time of the pixels PXs and the time required to compensate for the threshold voltage of the driving transistor increase, the occurrence of Mura may decrease.

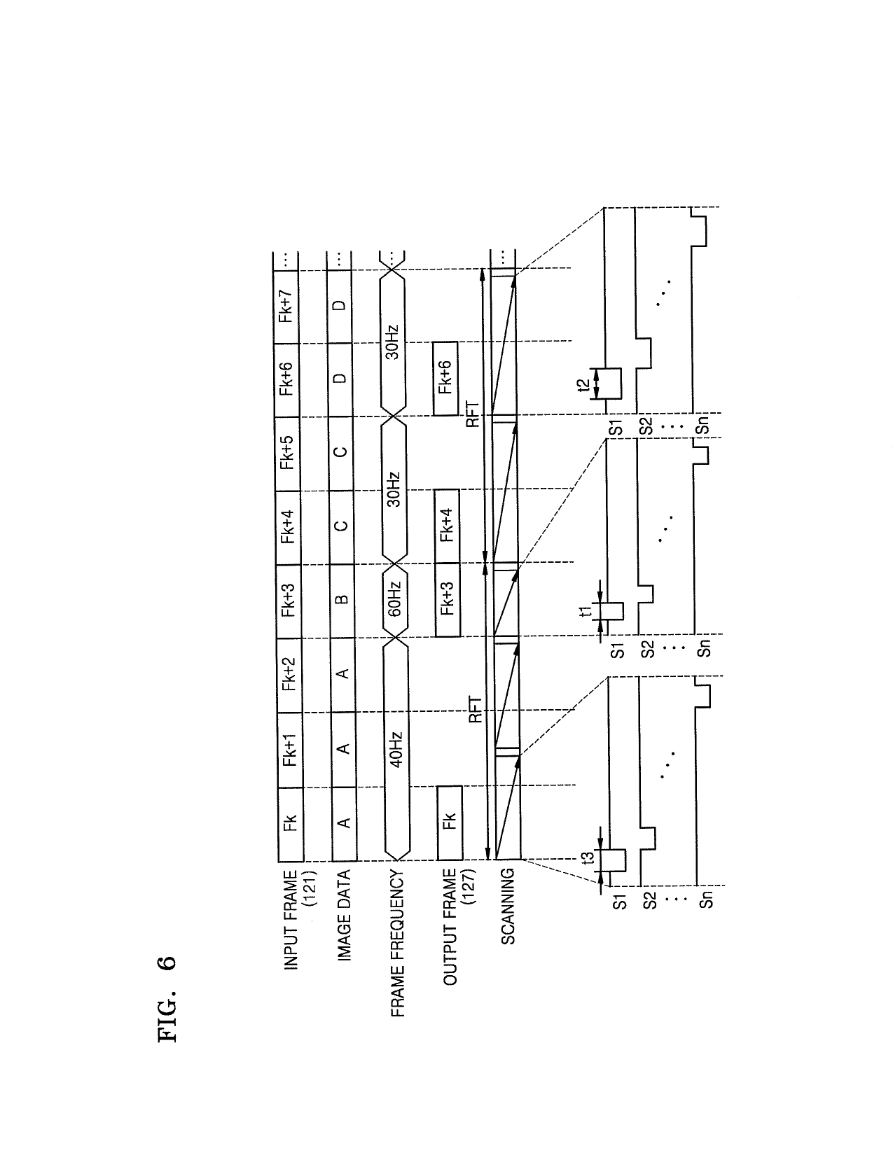

FIG. 6 illustrates another example of control signals for the display apparatus 10. In this exemplary embodiment, an original frame frequency is 60 Hz, the frame input unit 121 includes five frame memories, and a reference frame time RFT is four frame times. Image signals are sequentially input and stored to the frame input unit 121 in a frame unit (e.g., Fk, Fk+1, . . . , Fk+7, . . . ). The frame input unit 121 stores the input image signals to empty frame memories.

The image analyzer 123 compares image data of a current frame with that of a previous frame (e.g., Fk/Fk+1, Fk+1/Fk+2, Fk+2/Fk+3, Fk+3/Fk+4, . . . ) and determines the uniformity of the current frame and the previous frame. The image analyzer 123 determines the uniformity of frames input during the reference frame time RFT. For example, the image analyzer 123 determines the uniformity of frames, for example, first to fourth frames (Fk/Fk+1/Fk+2/Fk+3), fifth to eighth frames (Fk+4/Fk+5/Fk+6/Fk+7), or the like, which are input during four frame times.

The control signal generation unit 125 determines a frame frequency, in accordance with a determination result regarding the uniformity of frames, in a reference frame time RFT unit. When it is determined that the first to third frames (Fk/Fk+1/Fk+2) have uniformity, the control signal generation unit 125 changes the frame frequency of the first to third frames (Fk/Fk+1/Fk+2) to another value (e.g., 40 Hz) and generates control signals. According to user settings, the frame frequency of the first to third frames (Fk/Fk+1/Fk+2) may be changed to still another value (e.g., 20 Hz) and control signals may be generated.

When it is determined that the fourth frame (Fk+3) is different from the first to third frames (Fk/Fk+1/Fk+2), the control signal generation unit 125 maintains a frame frequency of the fourth frame (Fk+3) to 60 Hz.

When it is determined that the fifth and sixth frames (Fk+4/Fk+5) and the seventh and eighth frames (Fk+6/Fk+7) have uniformity from among the fifth to eighth frames (Fk+4/Fk+5/Fk+6/Fk+7), the control signal generation unit 125 changes frame frequencies of the fifth and sixth frames (Fk+4/Fk+5) and seventh and eighth frames (Fk+6/Fk+7) to another value (e.g., 30 Hz) and generates control signals.

The frame output unit 127 selectively outputs frames after four frame time delays. The frame output unit 127 selects and outputs each one of the first to third frames (Fk/Fk+1/Fk+2), the fifth and sixth frames (Fk+4/Fk+5), and the seventh and eighth frames (Fk+6/Fk+7) which are the same within the reference frame time RFT, e.g., first, fifth, and seventh frames (Fk, Fk+4, and Fk+6). The frame output unit 127 selects and outputs different frames within the reference frame time RFT, e.g., third frame (Fk+3).

For example, the first to fourth frames (Fk/Fk+1/Fk+2/Fk+3) are input to the frame input unit 121 and the image analyzer 123 determines the uniformity thereof. In this case, the second to fourth frames (Fk+1/Fk+2/Fk+3) having uniformity with the first frame (Fk) may be erased from a frame memory. When it is determined that the first to third frames (Fk/Fk+1/Fk+2) have uniformity, the control signal generation unit 125 changes the frame frequency thereof to 40 Hz or 20 Hz and changes the frame frequency of the fourth frame (Fk+3), which is different from the first to third frames (Fk/Fk+1/Fk+2), to 60 Hz.

In the case of the frame frequency of 20 Hz, while the fifth to seventh frames (Fk+4/Fk+5/Fk+6) are being sequentially input to the frame input unit 121, the frame output unit 127 outputs the first frame (Fk) to the data driver 150. In the case of the frame frequency of 40 Hz, while the fifth to seventh frames (Fk+4/Fk+5/Fk+6) are being sequentially input to the frame input unit 121, the frame output unit 127 outputs the first frame (Fk) to the data driver 150 once or twice.

While the eighth frame (Fk+7) is input to the frame input unit 121, the frame output unit 127 outputs the fourth frame (Fk+3) to the data driver 150. Likewise, the image analyzer 123 determines the uniformity of the fifth to eighth frames (Fk+4/Fk+5/Fk+6/Fk+7). Since the fifth and sixth frames (Fk+4/Fk+5) and the seventh and eighth frames (Fk+6/Fk+7) have uniformity, the control signal generation unit 125 changes the frame frequency to 30 Hz. While a ninth frame (Fk+8) and a tenth frame (Fk+9) are sequentially input to the frame input unit 121, the frame output unit 127 outputs the fifth frame (Fk+4) to the data driver 150. While an eleventh frame (Fk+10) and a twelfth frame (Fk+11) are sequentially input to the frame input unit 121, the frame output unit 127 outputs the seventh frame (Fk+6) to the data driver 150.

The scan driver 140 outputs, to the pixel unit 110, scan signals having a second pulse width t2 during two frame times, according to the first control signals CONT1 corresponding to the frame frequency of 30 Hz. The data driver 150 outputs, to the pixel unit 110, image data of frames input by the frame output unit 127, in synchronization with the scan signals, according to second control signals CONT2 corresponding to a changed frame frequency of 30 Hz.

The scan driver 140 outputs, to the pixel unit 110, scan signals having a third pulse width t3 twice during three frame times according to first control signals CONT1 corresponding to the frame frequency of 40 Hz. The data driver 150 outputs, to the pixel unit 110, image data of frames input by the frame output unit 127, in synchronization with scan signals, according to the second control signals CONT2 corresponding to the frame frequency of 40 Hz. Since the first frame (Fk) is already stored in the data driver 150, image data of the first frame (Fk) may be output again.

When the frame frequency of 40 Hz is used, scanning is performed twice during three frame times. When the frame frequency of 30 Hz is used, scanning is performed once during two frame times. In this case, the pulse widths of the scan signals have the relationship: t2>t3>t1. As the pulse widths of the scan signals transmitted to the pixels PXs increase, the data write time of the pixels PXs and the time required to compensate for the threshold voltage of the driving transistor increase. As the time required to compensate for the threshold voltage of the driving transistor increases, the occurrence of Mura may decrease. When the frame frequency of 20 Hz is used, scanning is performed once during three frame times Thus, in this embodiment, the pulse width of the scan signal may set to be greater than t2.

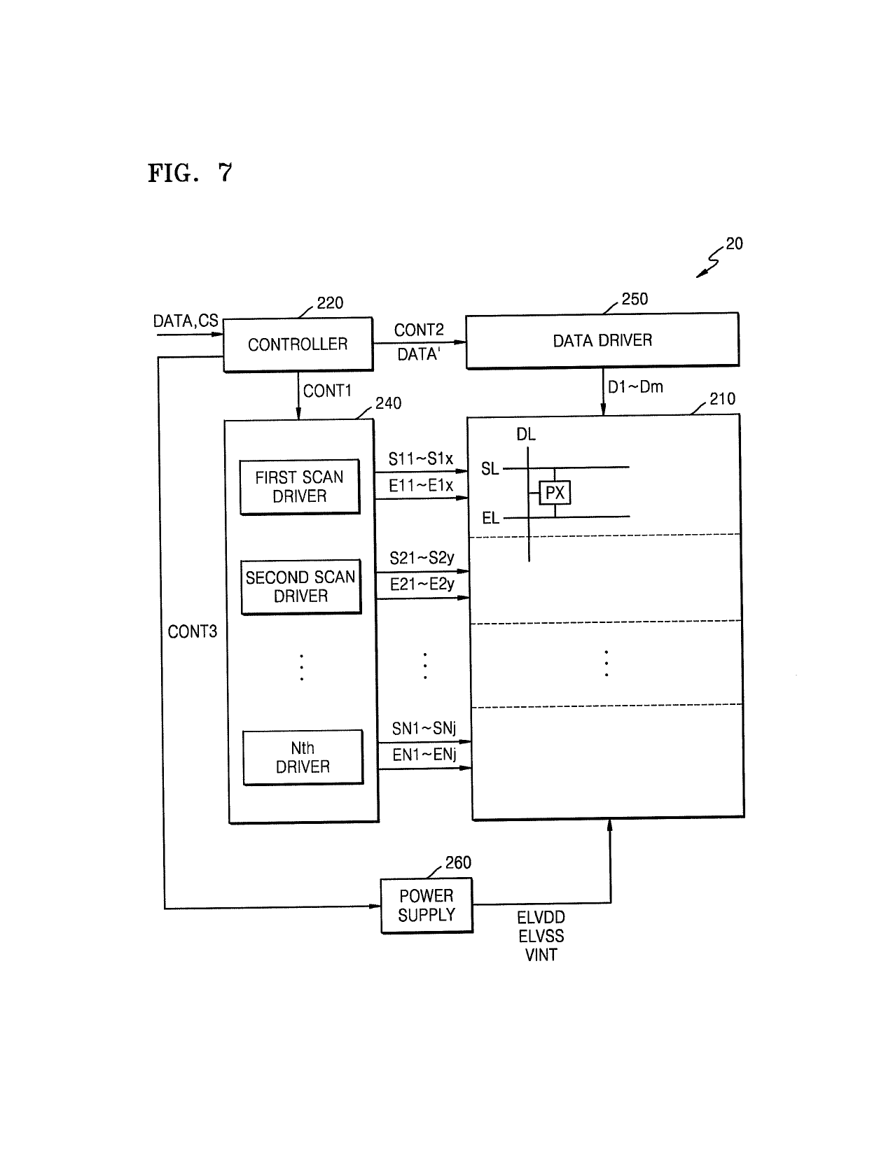

FIG. 7 illustrates another embodiment of a display apparatus 20 which includes a pixel unit 210, a controller 220, a scan driver 240, a data driver 250, and a power supply 260. The display apparatus 20 may be, for example, an organic light-emitting display apparatus.

The pixel unit 210 may be divided into a plurality of pixel areas. For example, the pixel unit 210 may be divided in accordance with a user interface (UI) displayed on a screen of the display apparatus 20. The sizes of respective pixel areas may be the same or different. For example, the pixel areas may include a region corresponding to a notification bar on a predetermined (e.g., upper) portion of the pixel unit 210, an icon region which is frequently used and disposed on a lower portion of the pixel unit 210, and an intermediate region. A plurality of scan lines SLs, a plurality of data lines DLs, a plurality of emission control lines ELs, a first power voltage line, and a plurality of pixels PXs may be arranged in each pixel area.

The controller 220 receives input image signals DATA and input control signals CSs from an external system. The controller 220 generates first control signals CONT1 and transmits the generated first control signals CONT1 to the scan driver 240. The controller 220 transmits the received image signals DATA′ and second control signals CONT2 to the data driver 250. The controller 220 generates third control signals CONT3 and transmits the generated third control signals CONT3 to the power supply 260.

The controller 220 stores the input image signals DATA in a frame unit and transmits the stored image signals DATA′ to the data driver 250. The controller 220 compares image data of adjacent frames with each other and determines the uniformity thereof. Then, according to a determination result regarding the uniformity of the adjacent frames, timings of a high level and a low level of the first control signals CONT1 and the second control signals CONT2, which are respectively output to the scan driver 140 and the data driver 150, are adjusted.

The scan driver 240 includes first to N^{th} scan drivers corresponding to the pixel areas. Each of the first to N^{th} scan drivers may include a shift register and may control scan timings of the pixel areas corresponding to the first to N^{th} scan drivers. For example, the first scan driver is connected to scan lines S in a first area of the pixel unit 210, generates scan signals S11 to S1x having a gate-on voltage according to the first control signals CONT1, and sequentially transmits the scan signals S11 to S1x to the scan lines SLs. The second scan driver is connected to scan lines SLs in a second area of the pixel unit 210, generates scan signals S21 to S2y according to the first control signals CONT1, and sequentially transmits the scan signals S21 to S2y to the scan lines SLs. The N^{th} scan driver is connected to a scan lines SLs in an N^{th} area of the pixel unit 210, generates scan signals SN1 to SNj having a gate-on voltage according to the first control signals CONT1, and sequentially transmits the scan signals SN1 to SNj to the scan line SL. The scan driver 240 controls a scan driver corresponding to at least one pixel area of a current frame. The at least one pixel area may have different image data from image data of a previous frame. In one exemplary embodiment, the pulse widths of the scan signals may increase using scan lines SLs of pixel areas having changed image data.

The scan driver 240 generates emission control signals E11 to E1x, E21 to E2y, . . . , EN1 to ENn having a gate-on voltage according to the first control signals CONT1. The emission control signals E11 to E1x, E21 to E2y, . . . , EN1 to ENn are sequentially transmitted to the emission control lines ELs in each pixel area.

The data driver 250 is connected to the data lines DLs in the pixel unit 210 and transmits data signals D1 to Dm to the data lines DLs according to the second control signals CONT2. The data driver 250 converts the image signals DATA′ input by the controller 220 to data signals in a voltage or current form.

The power supply 260 generates a first power voltage ELVDD and a second power voltage ELVSS according to the third control signals CONT3. The generated first power voltage ELVDD and second power voltage ELVSS are applied to the pixel unit 210. The power supply 260 generates an initialization voltage VINT according to the third control signals CONT3, and the initialization voltage VINT is applied to the pixel unit 210.

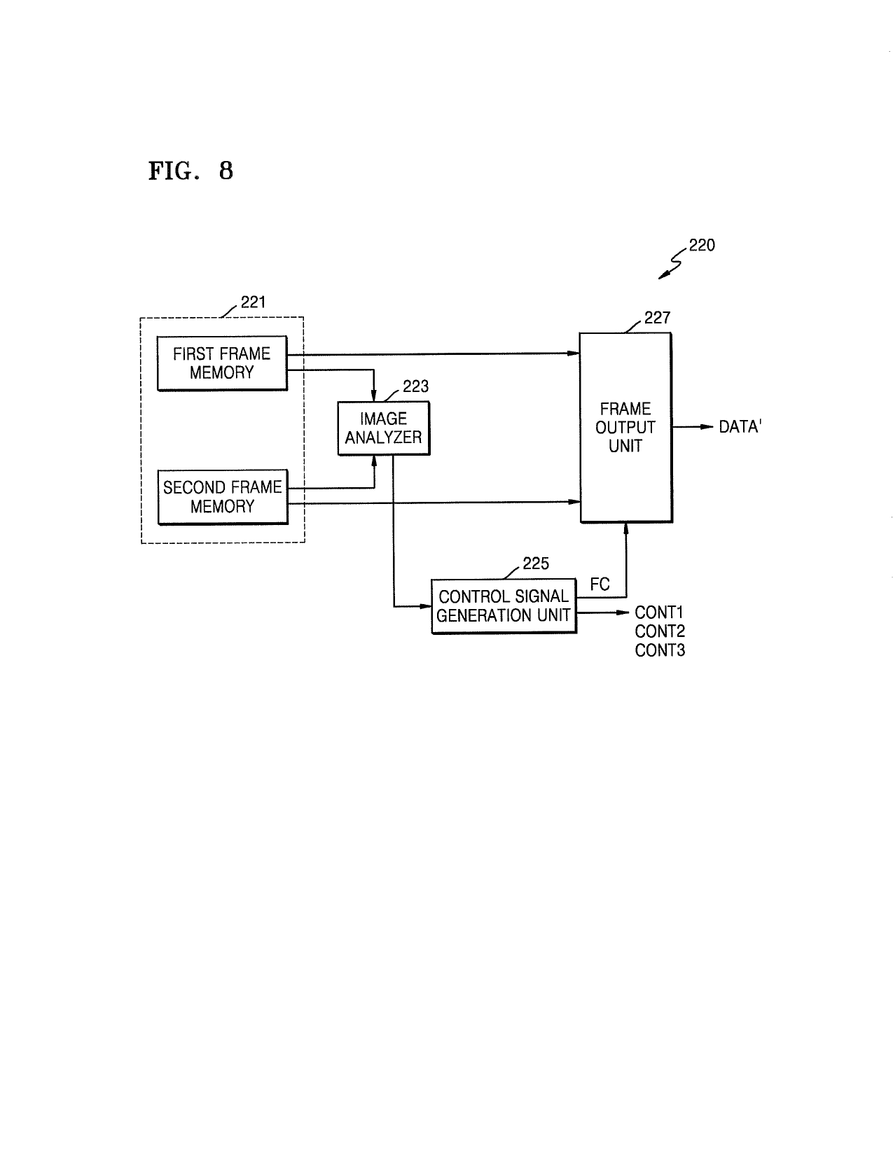

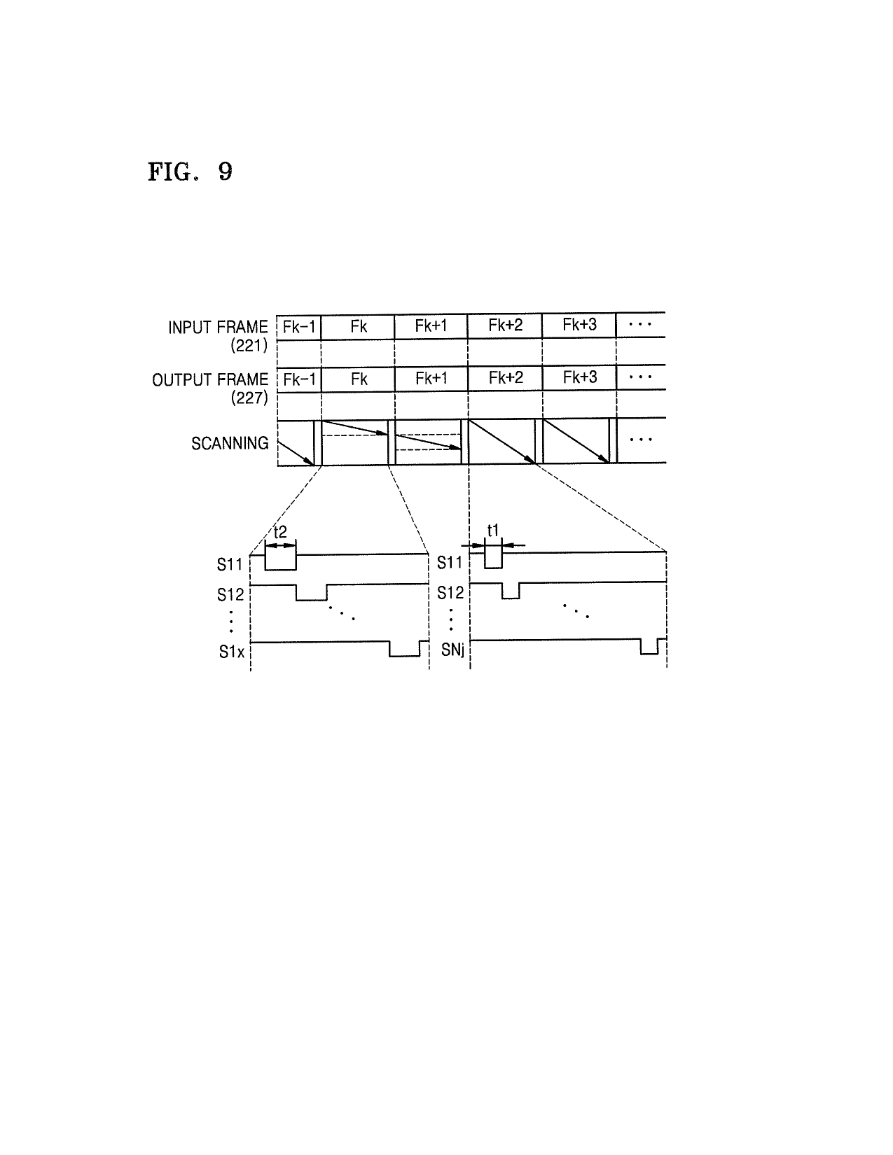

FIG. 8 illustrates another embodiment of the controller 220, and FIG. 9 illustrates an example of control signals for the display apparatus 20. Referring to FIG. 8, the controller 220 includes a frame input unit 221, an image analyzer 223, a control signal generation unit 225, and a frame output unit 227. The frame input unit 221 may include first and second frame memories. Images signals input may be alternately stored in the first and second frame memories in a frame unit.

The image analyzer 223 compares image data of a current frame with image data of a previous frame and determines the uniformity of the current frame and the previous frame. The image analyzer 223 may compare image data in corresponding areas of the current frame and the previous frame in pixel unit or block unit. Areas of frames respectively correspond to the pixel areas of the pixel unit 210. The image analyzer 223 compares each area of the current frame with that of the previous frame and classifies areas where the image data of the current frame differs from the image data of the previous frame.

The control signal generation unit 225 generates the first to third control signals CONT1 to CONT3. The control signal generation unit 225 changes the first control signals CONT1 and the second control signals CONT2. For example, scan signals and changed image data are transmitted only to an area (hereinafter, referred to as the ‘changed area’) of the current frame where the image data is different from the image data of the previous frame.

The control signal generation unit 225 generates a frame control signal FC for output to the frame output unit 227. The frame output unit 227 receives the frame control signal FC from the control signal generation unit 225 and outputs image data of one or more changed areas of the current frame to the data driver 250.

The scan driver 240 allows one or more scan drivers corresponding to the changed areas to sequentially output scan signals during one frame time according to the first control signals CONT1. Since the number of scanning operations during one frame time decreases, a pulse width of the scan signals may increase. The data driver 250 transmits, to the pixel unit 210, data signals of the changed areas in synchronization with the scan signals.

In the exemplary embodiment of FIG. 9, a first area of a K^{th} frame (Fk) has changed image data in comparison with a previous frame (Fk−1), where the first area is disposed on an upper portion of the K^{th} frame (Fk). Accordingly, a scan driver corresponding to the first area transmits scan signals S11 to S1x to scan lines SLs of the first area during one frame time. The data driver 250 transmits data signals of the first area to the first area in synchronization with the scan signals.

An entire area of a (k+2)^{th} frame (Fk+2) has changed image data in comparison with a previous frame (Fk+1). Thus, scan drivers corresponding to the entire area of the pixel unit 210 sequentially operate and output scan signals S11 to SNj to scan lines SLs of the entire area of the pixel unit 210 during one frame time.

Since the number of scanning operations in the K^{th} frame (Fk) during one frame time is less than the number of scanning operations in the (k+2)^{th} frame (Fk+2), a pulse width t2 of a scan signal used to display the K^{th} frame (Fk) may be greater than a pulse width t1 of a scan signal used to display the (k+2)^{th} frame (Fk+2). Thus, the data write time of pixels PXs and the time required to compensate for the threshold voltages of the driving transistors increase. As a result, the occurrence of Mura in an image may decrease.

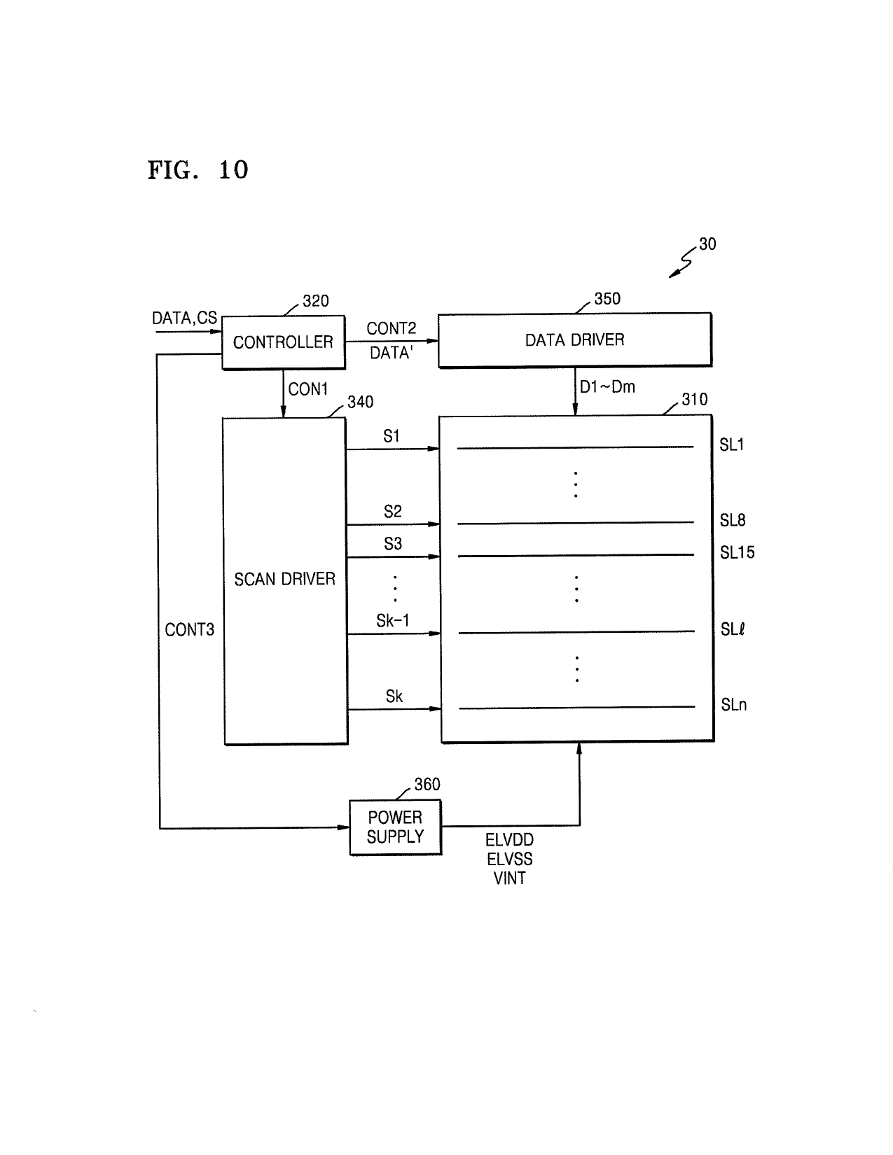

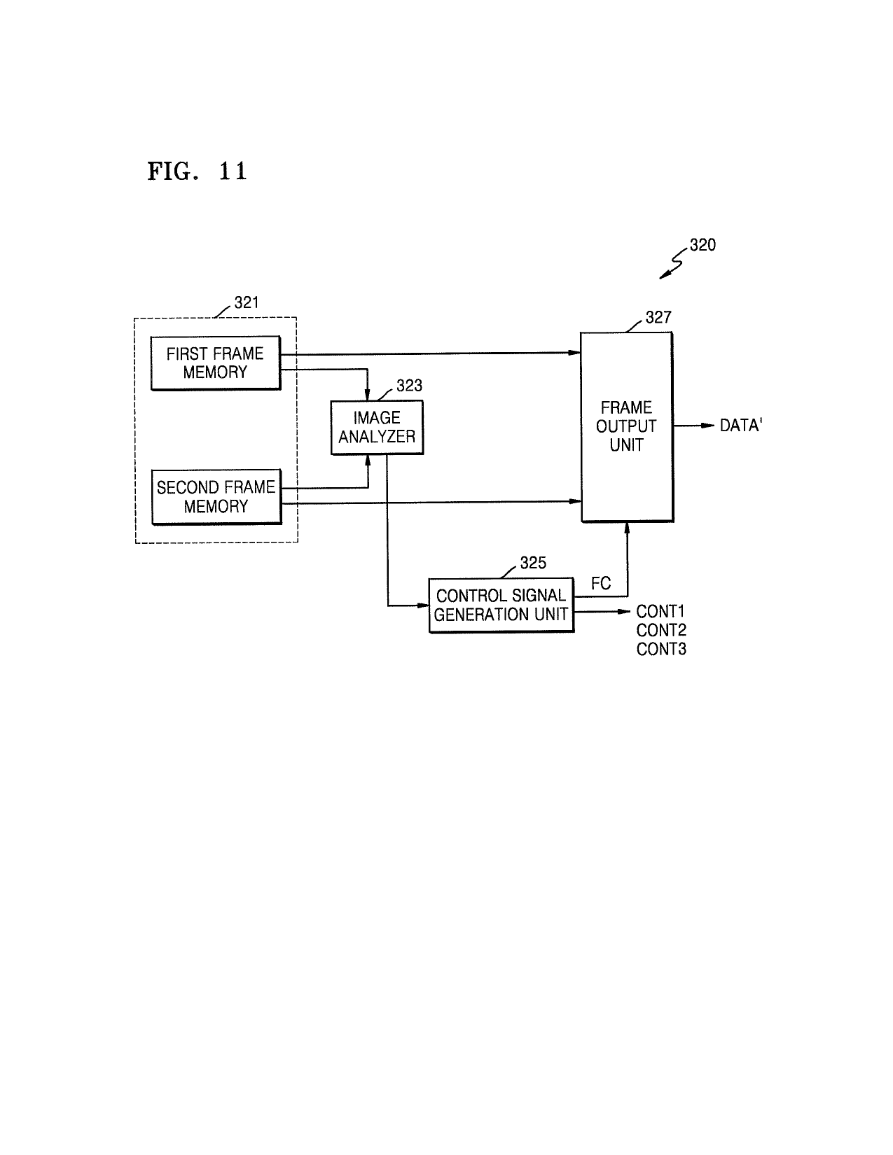

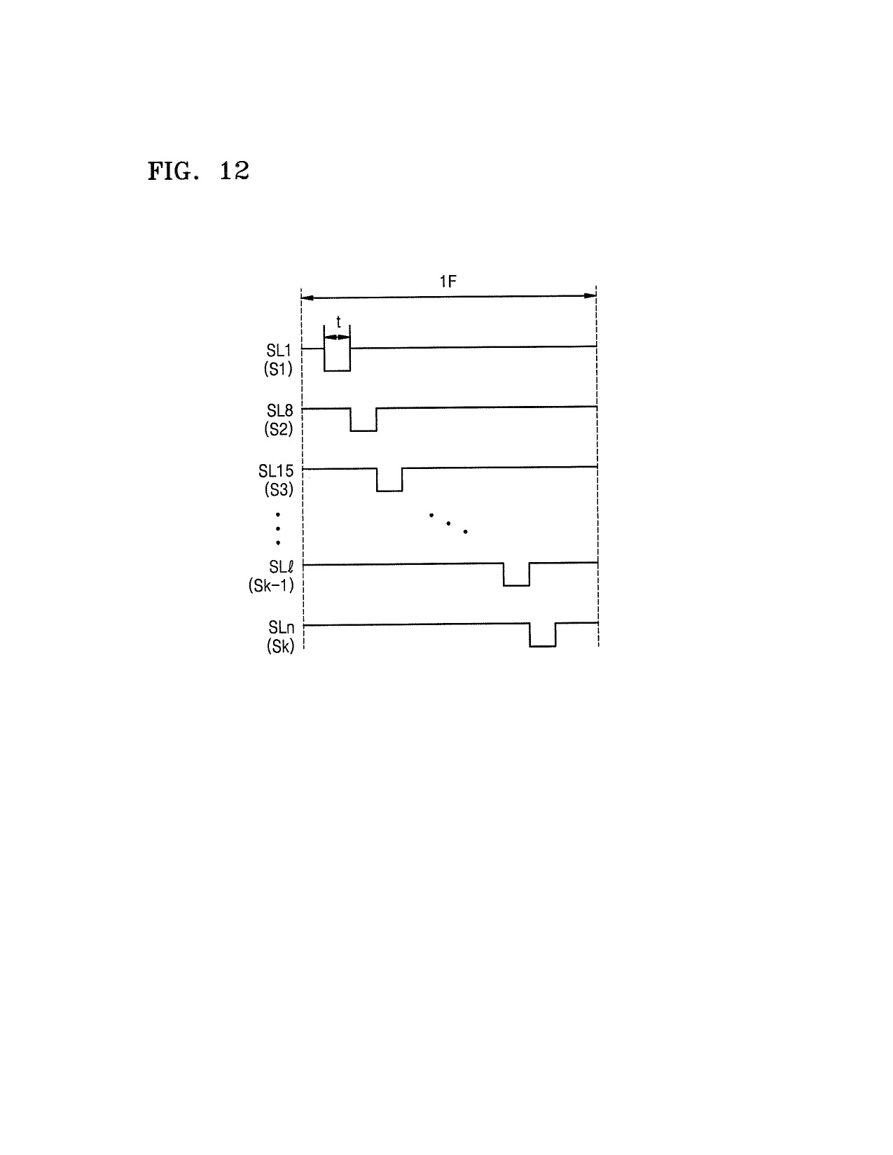

FIG. 10 illustrates another embodiment of a display apparatus 30, FIG. 11 illustrates an embodiment of a controller 320 of the display apparatus 30, and FIG. 12 illustrates an example of control signals for the display apparatus 30.

Referring to FIGS. 10 and 11, the display apparatus 30 includes a pixel unit 310, a controller 320, a scan driver 340, a data driver 350, and a power supply 360. The display apparatus 20 may be, for example, an organic light-emitting display apparatus.

The controller 320 receives input image signals DATA and input control signals CSs, for example, from an external system. The controller 320 includes a frame input unit 321, an image analyzer 323, a control signal generation unit 325, and a frame output unit 327. The frame input unit 321 includes a first frame memory and a second frame memory. The input image signals DATA may be alternately stored in the first frame memory and the second frame memory in a frame unit.

The image analyzer 323 compares image data of a current frame with image data of a previous frame and determines the uniformity of the current frame and the previous frame. The image analyzer 323 compares the image data of corresponding lines of the current frame and the previous frame. Each line of a frame may correspond to a row of the pixel unit 310. The image analyzer 323 compares each line of the current frame with each corresponding line of the previous frame and determines whether there is any line having different image data in the current frame.

The control signal generation unit 325 generates first to third control signals CONT1 to CONT3. The control signal generation unit 325 changes the first and second control signals CONT1 to CONT2, such that scan signals and changed image data are transmitted only to rows which correspond to lines in which the image data is different from the image data of the previous frame. The control signal generation unit 325 generates a frame control signal FC for output to the frame output unit 327.

The frame output unit 327 receives the frame control signal FC from the control signal generation unit 325 and outputs, to the data driver 350, image data of one or more lines in the current frame.

The scan driver 340 individually controls each scan line SL in the pixel unit 310. The scan driver 340 selects scan lines SLs in the pixel unit 310 according to the first control signals CONT1 and sequentially transmit scan signals to the selected scan lines SLs. In this case, since the number of scanning operations during one frame time decreases in comparison with a case where all scan lines SLs are selected and scan signals are transmitted thereto, the pulse width of the scan signals may increase. The data driver 350 transmits, to the pixel unit 310, data signals changed in synchronization with the scan signals.

In the exemplary embodiment of FIG. 12, image data of first, eighth, fifteenth, . . . , l^{th}, and n^{th} lines of the current frame are changed in comparison with the previous frame. The controller 320 respectively transmits the first control signals CONT1 and the second control signals CONT2 to the scan driver 340 and the data driver 350 in accordance with a result of comparing the current frame with the previous frame. The controller 320 may only output changed image data of the current frame to the data driver 350.

The scan driver 340 sequentially transmits scan signals S1, S2, S3, . . . , Sk−1, and Sk in order to sequentially select first, eighth, fifteenth, . . . , l^{th}, and n^{th} scan lines SL1, SL8, SL15, . . . , SL1, and SLn according to the first control signals CONT1.

The data driver 350 transmits, to the pixel unit 310, changed image data of the current frame in synchronization with the scan signals.

In the present exemplary embodiment, the number of scan signals transmitted during one frame time decreases in comparison with a case where scan signals S1 to Sn are sequentially transmitted to the first to n^{th} scan lines SL1 to SLn during one frame time. Accordingly, the pulse width t of the scan signals may be greater. Therefore, the data write time of pixels PXs and the time required to compensate for the threshold voltage of the driving transistor increase, thereby allowing the occurrence of Mura to decrease.

In accordance with another embodiment, an apparatus includes an interface to receive image data of a current frame and image data of a previous frame; and a controller coupled to the interface to determine a correlation between the image data of the current and previous frames, the controller to generate at least one signal to increase a pulse width of one or more scan signals when the current frame and the previous frame are determined to have a predetermined correlation. The interface may be, for example, a signal line (e.g., signal lines between the frame memories and image analyzers of the aforementioned embodiments), or an input port of a chip embodying the image analyzer, or a block of code which controls the input of image data into the image analyzer, which also may be implemented in code. The controller may include the controller of any of the aforementioned embodiments, and in one case may also be considered to include one or more of the scan driver or data driver. The predetermined correlation may correspond any of the aforementioned types of uniformities, e.g., a predetermined ratio of same image data between the current and previous frames.

The controller, signal generators, and other processing features of the disclosed embodiments may be implemented in logic which, for example, may include hardware, software, or both. When implemented at least partially in hardware, the controller, signal generators, and other processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controller, signal generators, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

By way of summation and review, in accordance with one or more of the aforementioned embodiments, an increased line time may be secured by varying a frame frequency or decreasing the number of scanning operations based on selective scanning after a determination is made as to the uniformity of image data of each frame. This may allow a sufficient amount of time to be secured for compensating the threshold voltages of the driving transistors of the pixels. In addition, a less power may be consumed by lowering the driving frequency or decreasing the number of scanning operations. Also, the occurrence of Mura may decrease by changing the pulse width of scan signals after the uniformity of each frame of image signals is determined.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A display apparatus, comprising:
a pixel unit including a plurality of pixels connected to a plurality of scan lines and a plurality of data lines;
a controller to determine a correlation between a current frame and a previous frame; and
a scan driver to transmit scan signals to the scan lines, the scan signals having an increasing pulse width when the current frame and the previous frame have a predetermined degree of correlation.

2. The display apparatus as claimed in claim 1, wherein each of the pixels includes:
a first transistor having a gate electrode connected to one of the plurality of scan lines and a first electrode connected to one of the plurality of data lines;
a second transistor having a gate electrode connected to a second electrode of the first transistor, a first electrode connected to a power voltage line, and a second electrode connected to an emission device; and
a third transistor having a gate electrode connected to the one of the scan lines connected to the gate electrode of the first transistor, a first electrode, and a second electrode, wherein the first and second electrodes are respectively connected to the second electrode and the gate electrode of the second transistor.

3. The display apparatus as claimed in claim 1, wherein the controller includes:
a plurality of frame memories to store input image signals in a frame unit; and
an image analyzer to compare image data of the current frame with image data of the previous frame.

4. The display apparatus as claimed in claim 3, wherein the controller includes:
a frame output to output one frame among a plurality of continuous frames when a number of the continuous frames in a reference frame time have the predetermined degree of correlation.

5. The display apparatus as claimed in claim 4, wherein the scan driver is to transmit, to the plurality of scan lines, the scan signals having the increasing pulse width during a first frame time, corresponding to a number of continuous frames having the predetermined degree of correlation within the reference frame time.

6. The display apparatus as claimed in claim 5, wherein a number of times that the scanning signals are transmitted to each pixel during the first frame time is less than a number of continuous frames having the predetermined degree of correlation within the reference frame time.

7. The display apparatus as claimed in claim 4, wherein the image analyzer is to calculate one color ratio of the current frame and is to determine whether the one color ratio has a value equal to or greater than a reference value.

8. The display apparatus as claimed in claim 3, wherein the controller includes a frame output to output the image data of the current frame which is different from the image data of the previous frame.

9. The display apparatus as claimed in claim 8, wherein:
the pixel unit is divided into a plurality of pixel areas, and
the scan driver is to transmit scan signals having an increasing pulse width during one frame time to scan lines of the pixel areas which correspond to areas where image data is changed in the current frame.

10. The display apparatus as claimed in claim 8, wherein the scan driver transmits scan signals having an increasing pulse width during one frame time to rows of the pixel unit, which correspond to lines having changed image data in the current frame.

11. A method for driving a display apparatus, the method comprising:
determining correlation between a current frame and a previous frame; and
transmitting scan signals having an increasing pulse width to a plurality of scan lines when the current frame and the previous frame have a predetermined degree of correlation.

12. The method as claimed in claim 11, wherein each of a plurality of pixels of the display apparatus includes:
a first transistor having a gate electrode connected to one of a plurality of scan lines and a first electrode connected to one of a plurality of data lines;
a second transistor having a gate electrode connected to a second electrode of the first transistor, a first electrode connected to a power voltage line, and a second electrode connected to an emission device; and
a third transistor having a gate electrode connected to the one of the plurality of scan lines, to which the first electrode of the first transistor is connected, a first electrode, and a second electrode, wherein the first electrode and the second electrode are respectively connected to the gate electrode and the second electrode of the second transistor.

13. The method as claimed in claim 11, wherein the transmitting the scan signals includes:
when a number of continuous frames within a reference frame time have the predetermined degree of correlation, transmitting the scan signals having the increasing pulse width to the scan lines during a first frame time corresponding to the number of continuous frames having the predetermined degree of correlation.

14. The method as claimed in claim 13, wherein a number of times that scan signals are transmitted to each of a plurality of pixels in the display apparatus during the first frame time is less than the number of continuous frames having the predetermined degree of correlation during the reference frame time.

15. The method as claimed in claim 11, further comprising:
calculating one color ratio of the current frame, and
determining whether the one color ratio has a value equal to or greater than a reference value.

16. The method as claimed in claim 11, wherein transmitting the scan signals includes:
transmitting, during one frame time, scan signals having an increasing pulse width to a plurality of scan lines in pixel areas corresponding to areas of the current frame where image data is changed in the current frame.

17. The method as claimed in claim 11, wherein transmitting the scan signals includes:
transmitting, during one frame time, scan signals having an increasing pulse width to rows of a pixel unit including a plurality of pixels which correspond to lines in which image data is changed in the current frame.

18. An apparatus, comprising:
an interface to receive image data of a current frame and image data of a previous frame; and
a controller coupled to the interface to determine a correlation between the image data of the current and previous frames, the controller to generate at least one signal to increase a pulse width of one or more scan signals when the current frame and the previous frame are determined to have a predetermined degree of correlation.

19. The apparatus as claimed in claim 18, wherein the predetermined degree of correlation corresponds to a predetermined ratio of same image data between the current and previous frames.

20. The apparatus as claimed in claim 18, wherein the interface is coupled to a first memory and a second memory, the first memory to provide the image data of the current frame and the second memory to provide the image data of the previous frame.
